(19) United States
(12) Patent Application Publication
(10) Pub. No.: US 2025/0184964 A1
(43) Pub. Date: Jun. 5, 2025

(54) MONITORING PAGING OCCASIONS USING A LOW POWER RADIO

(71) Applicant: Lenovo (United States) Inc., Morrisville, NC (US)

(72) Inventors: Karthikeyan Ganesan, Kronberg Im Taunus (DE); Ali Ramadan Ali, Kraiburg (DE); Ravi Kuchibhotla, Chicago, IL (US)

(73) Assignee: Lenovo (United States) Inc., Morrisville, NC (US)

(21) Appl. No.: 19/054,612

(22) Filed: Feb. 14, 2025

(51) Int. Cl. H04W 68/02; H04W 52/02

(52) U.S. Cl. CPC H04W 68/02; H04W 52/0235

(57) ABSTRACT

Various aspects of the present disclosure relate to monitoring paging occasions using a low power radio. A user equipment (UE) includes a low power radio, a main power radio, and a processing system that monitors for at least one paging message during one or more low power radio paging occasions (LR-POs) and using the low power radio of the UE. The processing systems powers on the main radio of the UE based at least in part on a reception of the at least one paging message during at least one LR-PO of the one or more LR-POs.

### TECHNICAL FIELD

The present disclosure relates to wireless communications, and more specifically to monitoring paging occasions using a low power radio.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to monitor for at least one paging message during one or more low power radio paging occasions (LR-POs) and using the low power radio of the UE; and power on the main radio of the UE based at least in part on a reception of the at least one paging message during at least one LR-PO of the one or more LR-POs.

A processor (e.g., a standalone processor chipset, or a component of a UE) for wireless communication is described. The processor may be configured to, capable of, or operable to perform one or more operations as described herein. For example, the processor may be configured to, capable of, or operable to monitor for at least one paging message during one or more LR-POs and using a low power radio of a UE that includes the processor; and power on a main radio of the UE based at least in part on a reception of the at least one paging message during at least one LR-PO of the one or more LR-POs.

A method performed or performable by a UE for wireless communication is described. The method may include monitoring for at least one paging message during one or more LR-POs and using a low power radio of the UE; and powering on a main radio of the UE based at least in part on a reception of the at least one paging message during at least one LR-PO of the one or more LR-POs.

In some implementations of the UE, processor, and method described herein, the UE, processor, and method may further be configured to, capable of, performed, performable, or operable to perform one or more of intra-frequency cell measurement or inter-frequency cell measurement using the low power radio of the UE; and perform a cell selection or a cell reselection based at least in part on one or more of the performed intra-frequency cell measurement or the performed inter-frequency cell measurement.

In some implementations of the UE, processor, and method described herein, the UE, processor, and method may further be configured to, capable of, performed, performable, or operable to receive a configuration that indicates the at least one LR-PO.

In some implementations of the UE, processor, and method described herein, the UE, processor, and method may further be configured to, capable of, performed, performable, or operable to receive a configuration that indicates at least one paging cycle of one or more paging cycles, where the at least one paging message is monitored for during the at least one paging cycle.

In some implementations of the UE, processor, and method described herein, a sequence length of a temporary mobile subscriber identity (TMSI) of the UE is based at least in part on N x Q bits, where N refers to a number of groups, and where Q refers to a number of bits per group.

In some implementations of the UE, processor, and method described herein, the UE, processor, and method may further be configured to, capable of, performed, performable, or operable to receive a configuration that indicates a sequence; and detect reception of the at least one paging message during the at least one LR-PO based at least in part on reception of the sequence during the at least one LR-PO.

In some implementations of the UE, processor, and method described herein, the UE, processor, and method may further be configured to, capable of, performed, performable, or operable to receive a configuration that indicates a cyclic shift from a base sequence; and detect reception of the at least one paging message during the at least one LR-PO based at least in part on reception of the base sequence having the cyclic shift during the at least one LR-PO.

An NE (e.g., a base station) for wireless communication is described. The NE may be configured to, capable of, or operable to perform one or more operations as described herein. For example, the NE may be configured to, capable of, or operable to transmit a configuration for low power radio paging; and transmit at least one paging message during at least one low power radio paging occasion (LR-PO) of one or more LR-POs.

A processor (e.g., a standalone processor chipset, or a component of a NE (e.g., a base station)) for wireless communication is described. The processor may be configured to, capable of, or operable to perform one or more operations as described herein. For example, the processor may be configured to, capable of, or operable to transmit a configuration for low power radio paging; and transmit at least one paging message during at least one LR-PO of one or more LR-POs.

A method performed or performable by an NE (e.g., a base station) for wireless communication is described. The method may include transmitting a configuration for low power radio paging; and transmitting at least one paging message during at least one LR-PO of one or more LR-POs.

In some implementations of the NE, the processor, and the method described herein, the configuration indicates the at least one LR-PO.

In some implementations of the NE, the processor, and the method described herein, the configuration indicates at least one paging cycle of one or more paging cycles for a UE to monitor.

In some implementations of the NE, the processor, and the method described herein, a sequence length of a TMSI of a UE is based at least in part on N x Q bits, where N refers to a number of groups, and where Q refers to a number of bits per group.

In some implementations of the NE, the processor, and the method described herein, the configuration indicates a sequence, and the NE, processor, and method may further be configured to, capable of, performed, performable, or operable to transmit the sequence during the at least one LR-PO.

In some implementations of the NE, the processor, and the method described herein, the configuration indicates a cyclic shift from a base sequence, and the NE, processor, and method may further be configured to, capable of, performed, performable, or operable to transmit the base sequence having the cyclic shift during the at least one LR-PO.

### BRIEF DESCRIPTION OF THE DRAWINGS

FIG. 1 illustrates an example of a wireless communications system in accordance with aspects of the present disclosure.

FIG. 2 illustrates an example of a low-power wake-up radio (LP-WUR) design architecture in accordance with aspects of the present disclosure.

FIG. 3 illustrates an example of an overlaid sequence in accordance with aspects of the present disclosure.

FIG. 4 illustrates an example of a LP-WUR design architecture in accordance with aspects of the present disclosure.

FIG. 5 illustrates an example flowchart of transitioning between different radios in accordance with aspects of the present disclosure.

FIG. 6 illustrates an example of LR-POs in accordance with aspects of the present disclosure.

FIG. 7 illustrates an example of a low-power wake-up signal (LP-WUS) sequence generation in accordance with aspects of the present disclosure.

FIG. 8 illustrates an example of code division multiplexing in accordance with aspects of the present disclosure.

FIG. 9 illustrates an example of a main radio wake-up delay in accordance with aspects of the present disclosure.

FIG. 10 illustrates an example of mapping synchronization signal block (SSB) lower power paging occasions (POs) to random access channel (RACH) occasions.

FIG. 11 illustrates an example of a LP-WUR design architecture in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of a NE in accordance with aspects of the present disclosure.

FIG. 15 illustrates a flowchart of a method performed by a UE in accordance with aspects of the present disclosure.

FIG. 16 illustrates a flowchart of a method performed by a NE in accordance with aspects of the present disclosure.

### DETAILED DESCRIPTION

A UE may operate with different power consumption levels in different power consumption modes, such as in a mode with a high power consumption level (e.g., an active mode, a high-power mode, or a full-power mode) and a mode with a lower power consumption level (e.g., an idle mode, an inactive mode, or a low-power mode). A UE operating in a mode with lower power consumption may operate using reduced transmission and/or reception capabilities (e.g., due to reduced transmit power, energy efficient radio transceivers, low power processors, etc.), may utilize sleep modes for different components of the UE, or the like. In some examples, a wireless device (e.g., a UE) may include multiple components (e.g., multiple radios or multiple receivers), such as a low-power component that operates using a low power consumption level (e.g., a low-power radio, a low-power receiver, or a LP-WUR), and a high-power component that operates at a higher power consumption level (e.g., a main power radio (also referred to as a main radio), a main receiver). The UE may transition from the high-power component being activated, operating, or executing to the high-power component being not activated, not operating, or not executing, also referred to as the high-power component being put to sleep or transferring to a sleep mode. The UE may transition from the high-power component being not activated, not operating, or not executing to the high-power component being activated, operating, or executing, also referred to as the high-power component being woken up, transferring to a wake mode, or waking up the high-power component.

Traditionally, the UE can receive a wake-up signal (WUS), such as an LP-WUS, from an NE. A low-power component (e.g., a LP-WUR or a low-power receiver) of the UE determines whether the WUS identifies the UE. If the WUS identifies the UE (e.g., identifies a subgroup that includes the UE), the low-power component (e.g., a LP-WUR or a low-power receiver) wakes up a high-power component (e.g., a main radio or main receiver) of the UE to monitor the paging occasion (PO). If the WUS does not identify the UE (e.g., does not identify a subgroup that includes the UE), the low-power component (e.g., a LP-WUR or a low-power receiver) does not wake up the high-power component (e.g., a main radio or main receiver) in response to or based on the received WUS.

UEs are typically organized into subgroups and when the NE desires to wake up a target UE (e.g., for an incoming phone call, to communicate, send, or receive data to and/or from the UE), the NE sends a LP-WUS to the subgroup that includes the target UE. Accordingly, the main radios of all of the UEs in the subgroup are woken up to monitor the PO. The target UE receives the paging message in the PO whereas the other UEs in the group determine that they are not the ones being paged, and the main radios of those UEs go back to sleep. Thus, the UEs in the subgroup that are not being paged are unnecessarily woken up. Using the techniques discussed herein, the LP-WUR monitors the PO and wakes up the main radio (or another radio that is higher-powered than the LP-WUR) in response to or based at least in part on receiving a paging message in the PO. By having the LP-WUR monitor the paging occasions and receive the paging message, the main radios of UEs that are not being paged can be left in an inactive or sleep, thereby conserving power.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

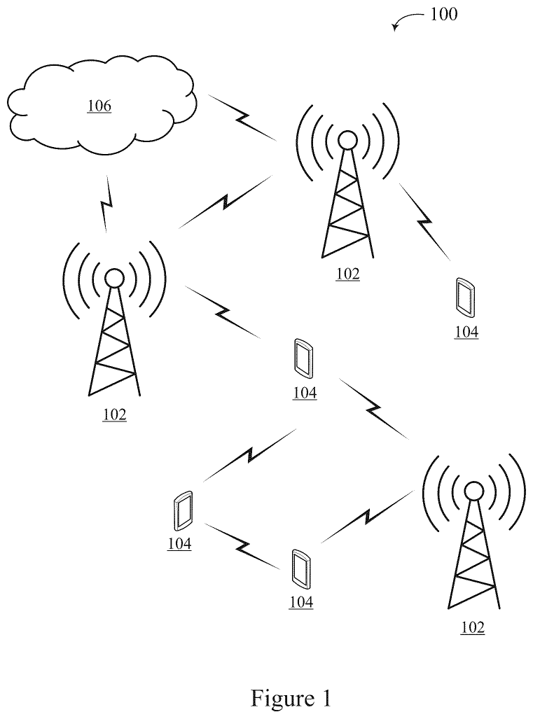

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, an access point (AP), a network clement, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologics (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some cases, a cell refers to a radio access node in communication with a base station or including a base station. A cell typically has a coverage area, which is a geographic area in which the cell provides wireless connectivity to devices within. Different cells may operate on defined frequencies or frequency bands, referred to as subcarriers. In some examples, a UE 104 establishes a wireless connection with a cell, and subsequently that cell may be referred to as a serving cell of the UE 104.

A UE 104 includes a low power radio and a main power radio. The UE 104 may transition the main radio (also referred to as the main power radio) to a low power state (e.g., powered off, powered down, a sleep state, a deep sleep state, an ultra deep sleep state) due to there being no data to communicate (e.g., transmit, send, receive, signal) to and/or from the NE 102. While the main radio is in the low power state, the NE 102 may communicate (e.g., signal, transmit, send) at least one paging message during one or more LR-POs. The low power radio of the UE monitors the one or more LR-POs for the at least one paging message, and in response to or based at least in part on reception of the at least one paging message during at least one LR-PO of the one or more LR-POs, cause the main radio to transition to a high power state (e.g., powered on, powered up, activated).

A low power radio refers to a radio that operates at a lower power level, consuming less energy, than the main radio. For example, the low power radio may operate at a lower frequency than the main radio, the low power radio may have fewer antennas than the main radio, the low power radio may be a receive only (no transmit) radio, the low power radio may communicate (e.g., receive, retrieve, obtain, send, transmit, signal) at a lower data rate than the main radio, and so forth.

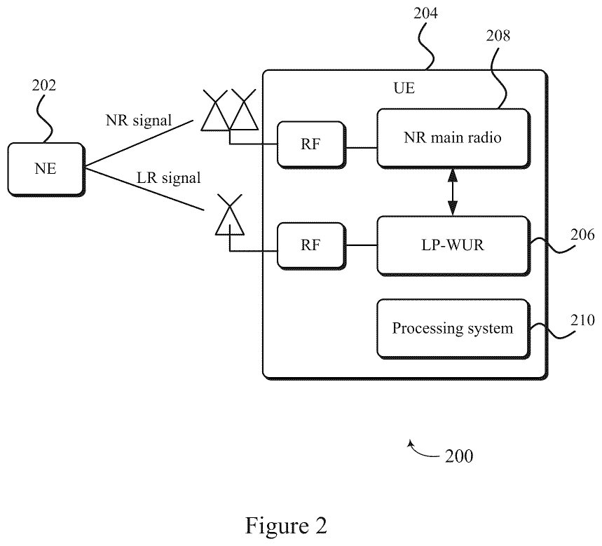

FIG. 2 illustrates an example 200 of a LP-WUR design architecture in accordance with aspects of the present disclosure. The example 200 illustrates an NE 202 (e.g., a base station) and a UE 204. The NE 202 is, for example, an NE 102 of FIG. 1. The UE 204 is, for example, a UE 104 of FIG. 1. The UE 204 includes a LP-WUR 206, a main radio 208, and a processing system 210 that includes processor circuitry and memory circuitry. Although illustrated as separate from the LP-WUR 206 and the main radio 208, additionally, or alternatively, the processing system 210 may be included in the LP-WUR 206 and/or the main radio 208. The NE 202 transmits a low power radio (LR) signal, such as LP-WUS, that is received by the LP-WUR 206, which can wake up the main radio 208 (e.g., main receiver) of the UE 204. The UE 204 then communicates (e.g., signals, transmits, receives) with the NE 202 using the main radio. The LP-WUR 206 can be, for example, a chipset separate from the main radio 208, a coprocessor separate from the main radio 208, a configuration within the same main radio 208, and the like. The NE 202 may also transmit other low power radio (LR) signals to the UE 204, such as LR-PO signals as discussed in more detail below. The LP-WUR 206 can support or operate using multiple levels of power lower than the power of the main radio, such as a low power level for receiving a LP-WUS from the NE 202 and a middle power level for receiving low data rate data or commands (e.g., IoT communications). This middle power level is a higher power level (and consumes more power) than the low power level, but is a lower power level (and consumes less power) than the main radio 208.

The techniques discussed herein describe a new wake up radio procedure to wake up the main radio 208 after receiving paging information using a low power radio (e.g., the LP-WUR 206 operating in a middle power level) is described to improve the power saving for the UE 204 in the idle mode.

Use cases for low-power wake-up signal and receiver for NR Air Interface is taken into consideration. These use cases include LP-WUS/LP-WUR for power-sensitive, small form-factor devices including IoT use cases (such as industrial sensors, controllers) and wearables. Other use cases include, e.g., extended reality (XR)/smart glasses, smart phones.

The design of low power wake up signal residing in the low power wake up radio which may be used to wake up the main radio is taken into consideration. For waveform generation the following observations are taken into consideration: flat spectrum in frequency domain provides robustness against frequency selective fading compared to concentrated energy in frequency domain; for on-off keying 4 (OOK-4), sequence before discrete Fourier transform (DFT) or low-band spectrum (LS) with variation in phase via such as Zadoff-Chu (ZC), M-sequence or quadrature amplitude modulation (QAM) sequence can achieve more flattened spectrum; knowledge of one or more sequences used in LP-WUS waveform generation may improve performance for at least a receiver with in-phase and quadrature (I/Q) branches; for waveform-option-3, a harmonized design that accommodates on-off keying 1 (OOK-1)/OOK-4 and orthogonal frequency division multiplexing (OFDM) waveform, e.g., specified overlayed orthogonal frequency division multiplexing (OFDM) sequences over OOK symbol; for radio resource control (RRC) IDLE/INACTIVE, in addition to existing primary synchronization signal (PSS) or secondary synchronization signal (SSS), low power synchronization signal (LP-SS) (e.g., one or both of OOK-1/or OOK-4 waveform with or without overlayed OFDM sequences with potential further down selection in WI phase) for LP-WUR that cannot receive existing PSS/SSS, is supported for synchronization and/or radio resource management (RRM) for serving cell.

The problem of power saving as well as coverage associated with the LP-WUR is taken into consideration. The receiver based on envelope detector receiving the OOK waveform improves (e.g., maximizes) the power saving gain compared to the IQ correlator, however the coverage of receiver based on envelope detector is limited compared to the coverage of the IQ correlator receiver type.

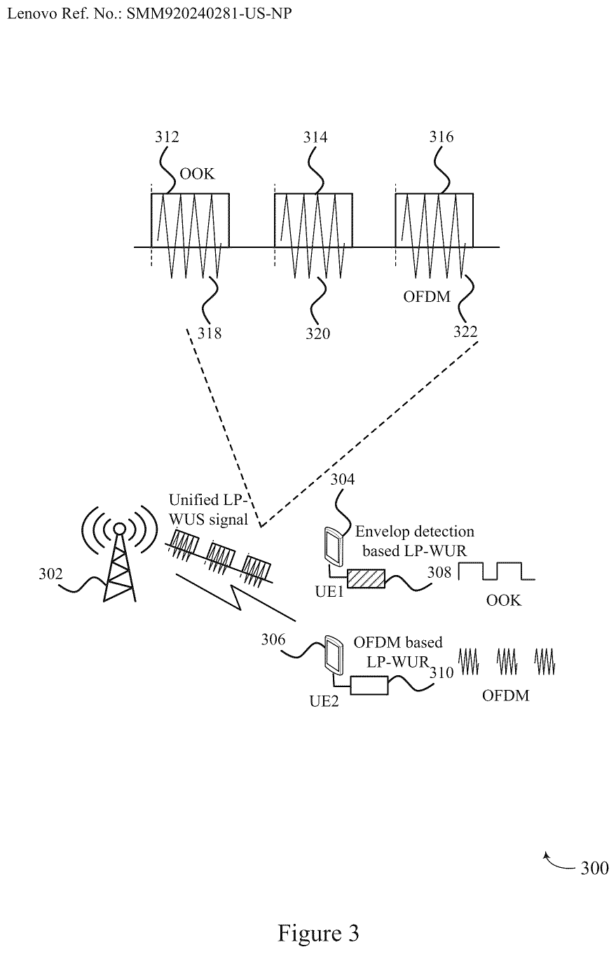

FIG. 3 illustrates an example 300 of an overlaid sequence in accordance with aspects of the present disclosure. The example 300 illustrates an NE 302 (e.g., a base station), a UE 304, and a UE 306. The NE 302 is, for example, an NE 102 of FIG. 1. The UE 304 and the UE 306 are each, for example, a UE 104 of FIG. 1. The UEs 304 and 306 can have different types of receivers, illustrated as UE 304 having an OOK receiver 308 and the UE 306 having an OFDM receiver 310. The NE 302 transmits a waveform that is an overlaid sequence, using OOK and an OFDM sequence during each “on” part of the OOK transmission. For example, during each “on” part 312, 314, and 316 of the OOK transmission, the NE 302 transmits an OFDM sequence 318, 320, and 322, respectively.

Returning to FIG. 2, with respect to the LP-WUR 206, in RRC Idle state the UE 204 receives a wake-up signal and performs a serving cell measurement. In RRC Connected state, the LP-WUS replaces downlink control information (DCI) 2_6—wake-up main radio for connected mode discontinuous reception (C_DRX) active time and the dynamic active timer configuration.

With regard to the overlaid OFDM sequence(s) of LP-WUS, the following options are taken into consideration. In Option 1, a single overlaid sequence is on each OOK ‘ON’ symbol or OFDM symbol duration. OFDM-based LP-WUR can obtain the whole information bits by the presence of the overlaid sequence. In Option 1-2, the overlaid OFDM sequence is pre-determined from multiple sequences. This sequence carries NO information bits of LP-WUS. OFDM-based LP-WUR can obtain the whole information bits by the OOK ON/OFF pattern.

In Option 2, one sequence is selected from multiple candidates overlaid OFDM sequences on each OOK ‘ON’ symbol or OFDM symbol duration, and OFDM-based LP-WUR obtain LP-WUS information at least by overlaid OFDM sequence(s). Two sub-options are taken into consideration. In Option 2-1, the overlaid OFDM sequence(s) carry part of information bits of LP-WUS. OFDM-based LP-WUR can obtain the whole information bits by OFDM sequence(s) and location of the OFDM sequence(s)/OOK symbols. In Option 2-2, the overlaid OFDM sequence(s) carry all information bits of LP-WUS. OFDM-based LP-WUR can obtain the whole information bits by the overlaid OFDM sequence(s).

In Option 3, one sequence is selected from multiple candidates overlaid OFDM sequences on one or more OOK ‘ON’ symbols, and OFDM-based LP-WUR obtains LP-WUS information at least by overlaid OFDM sequence(s). In Option 4, use of modulated overlay sequence with constellation point is used: overlay sequence acting as a spreading sequence and constellation point carrying information for OFDM-based LP-WUR. Additionally, or alternatively, other options can be taken into consideration.

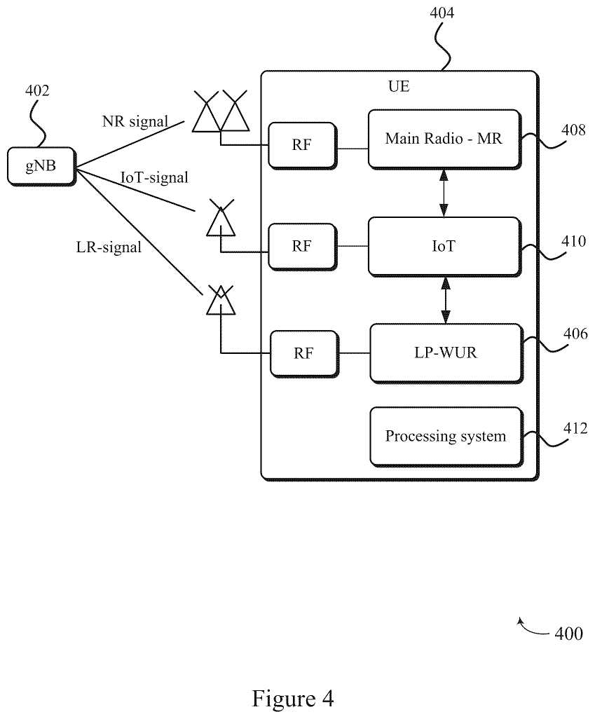

FIG. 4 illustrates an example 400 of a LP-WUR design architecture in accordance with aspects of the present disclosure. The example 400 illustrates an NE 402 (e.g., a base station) and a UE 404. The NE 402 is, for example, an NE 102 of FIG. 1. The UE 404 is, for example, a UE 104 of FIG. 1. The UE 404 includes a LP-WUR 406, and a main radio 408, an IoT radio 410, and a processing system 412 that includes processor circuitry and memory circuitry. Although illustrated as separate from the LP-WUR 406, the main radio 408, and the IoT radio 410, additionally, or alternatively, the processing system 412 may be included in the LP-WUR 406, the main radio 408, and/or the IoT radio 410. The NE 402 transmits a LR signal, such as LP-WUS, that is received by the LP-WUR 406, which can wake up the main radio 408 (e.g., main receiver) of the UE 404. The UE 404 then communicates (e.g., signals, transmits, receives) with the NE 402 using the main radio. The LP-WUR 406 can be, for example, a chipset separate from the main radio 408, a coprocessor separate from the main radio 408, a configuration within the same main radio 408, and the like. The NE 402 may also transmit other LR signals to the UE 204, such as LR-PO signals.

The UE 404 also includes the IoT radio 410, which can operate at higher power level (and thus higher energy consumption) than the LP-WUR 406 but a lower power level (and thus lower power consumption) than the main radio 408. The IoT radio 410 can be woken up (e.g., by the LP-WUR 406 or the main radio 408) to communicate (e.g., receive and/or transmit) data and/or control information at a low data rate, and the main radio 408 can be woken up (e.g., by the LP-WUR 406) to communicate (e.g., receive and/or transmit) data and/or control information at a high data rate. When there is no data and/or control information to be communicated (e.g., received and/or transmitted) by the main radio 408, the main radio 408 can transition to a sleep or deep sleep state (e.g., powered off). Similarly, when there is no data and/or control information to be communicated (e.g., received and/or transmitted) by the IoT radio 410, the IoT radio 410 can transition to a sleep or deep sleep state (e.g., powered off).

The LP-WUR 406 can be integrated as a coprocessor or a separate auxiliary chipset to wake up the main radio 408 handling high data rate traffic and the low power IoT radio 410 handling low data rate traffic. The low power IoT radio 410 can be achieved by configuration, such as reduced bandwidth relative to the main radio 408, different antenna than the main radio 408, and so forth. Hence, the UE 404 can use two configuration such as LR-WUR (also referred to as LP-WUR) and/or LR-IT (also referred to as LP-IoT).

The main radio 408 can enter wake up the LP-WUR 406 or the low power IoT radio 410 depending on the functionality. The main radio 408 can evaluate the entry condition for low power wake up radio or low power IoT radio in the idle mode depending on the inactivity period.

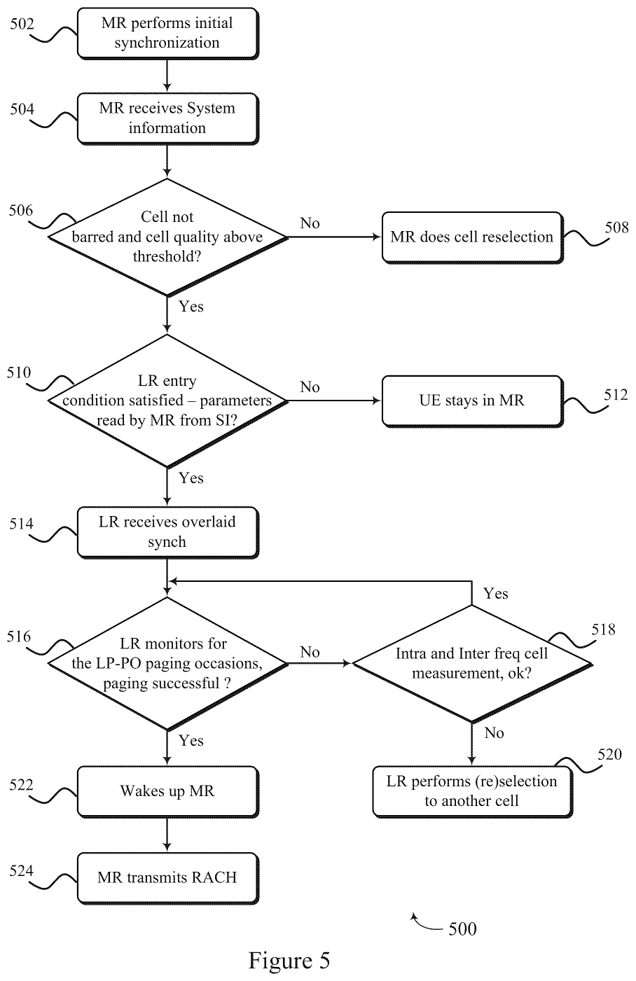

FIG. 5 illustrates an example flowchart 500 of transitioning between different radios in accordance with aspects of the present disclosure. The flowchart 500 may implement aspects of the wireless communications system 100 of FIG. 1. The flowchart 500 may be implemented by a UE 102.

At 502, the main radio of the UE wakes up and perform the frequency raster synchronization in case of no previously stored cell or may check the frequency corresponding to the previously stored cell. As part of the synchronization procedure, at 504 the main radio receives system information, such as one or more synchronization signal blocks (SSBs) from the cell and performs the SSB measurements of one or more cells.

At 506, once the main radio selects the cell with the best received SSB according to the received reference signal received power (RSRP)/reference signal received quality (RSRQ)/received signal strength indicator (RSSI), then the UE may proceed to read the control resource set (CORESET) #0 and SIB #1 from that cell and finds whether the cell is barred or not for communication. A cell may be barred for various reasons, such as network congestion management, the cell is designated for emergency calls only, system maintenance may be being performed by the cell, and the like. If the cell is barred then at 508 the main radio performs the cell re-selection and find another cell.

At 510, the main radio evaluates the entry condition for a low power radio, e.g., the loT radio 410 of FIG. 4, the LP-WUR 406 of FIG. 4, or a LP-WUR mode of a low power radio by checking the entry condition. The entry condition can be a period of time when there is no reception of paging reception for a UE, e.g., the UE starts a timer, and until the expiry of the timer when there is no successful paging from that UE, the UE may evaluate the entry condition for the low power radio and may enter the low power radio. At 512, if the UE receives a successful paging the UE stops the timer and remains using the main radio. The duration of the timer can be an integer multiple of its paging cycle or paging time window in case of eDRX. Additionally, or alternatively, the UE may be receiving short group messages, e.g., emergency notification, system information (SI) update notification etc., in paging and short text message for the user. The UE may decide to wake up the LR-IoT radio 410 depending on the entry condition. In this case, the entry condition is evaluated based on the extended coverage met by the LR-IoT radio 410 and not met by the main radio by receiving multiple repetitions of the message by the LR-IoT radio 410 and save power by not frequently waking up the main radio to receive short messages.

At 514 and 516, when the main radio and the IoT radio (if any) are in a sleep or deep sleep mode, the UE enters an LR-WUR mode and the LP-WUR of the UE may monitor for the early paging indication to wake up a subgroup, while the paging can be grouped in a paging frame and paging occasion. The LR-WUR can also be configured to monitor an early paging indicator and/or paging occasions.

Typically, the paging occasions contain 32 paging records to group UEs using RRC messaging where each paging record contains a 5G-S-TMSI, which is a 48 bit value, to page a UE. However, delivering up to 48*32 bits as a RRC container in a paging occasion is a huge payload increase for the LP-WUR. However, a different signal design can allow paging messages to be delivered to the LP-WUR. The number of paging records multiplexed within a LR paging monitoring occasion can be configured and a different paging frame and paging occasion formula can be derived for the LP-WUR compared to the legacy paging.

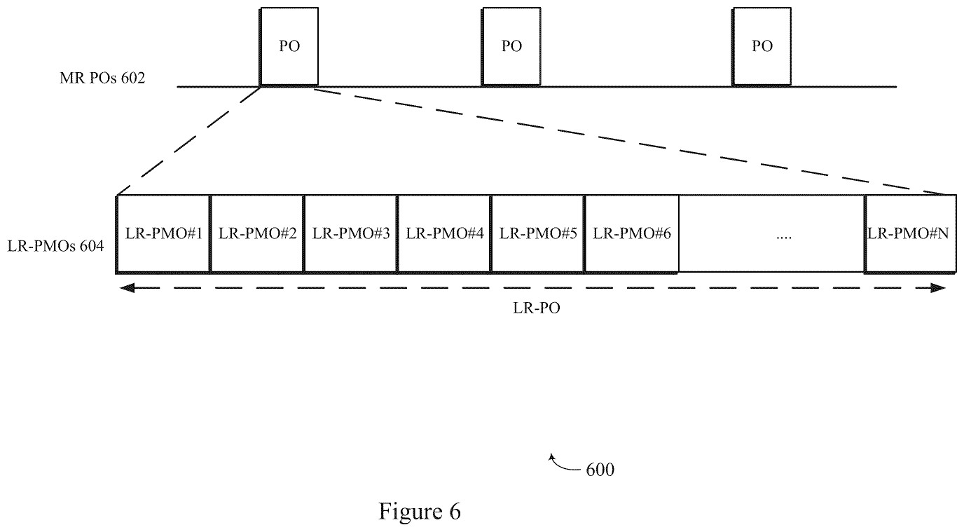

The UE may be configured for the LP-WUR to monitor at least one low power radio paging occasions (LR-POs). FIG. 6 illustrates an example 600 of LR-POs in accordance with aspects of the present disclosure. The example 600 illustrates main radio POs 602, each of which has multiple (N) LR-paging monitoring occasions (LR-PMOs) 604. The number (N) of LR-PMOs can be, for example, the number of paging records used to group UEs (e.g., 32 as discussed above). In one or more implementations, the UEs may be configured to monitor a LR-PO occasion where each UE's LP-WUR may be configured with at least one codepoint each representing at least one paging record to monitor for its paging message as a LR-paging monitoring occasion (LR-PMO). The number of LR-POs within a paging cycle or across paging cycles can be configured by the NE (e.g., a base station). Thus, rather than monitoring all LR-POs, each UE can be configured with one PO to monitor for its paging message. LR of UEs can be configured to monitor at least one LR-PO per paging cycle and there can be a plurality of LR-PMOs within a LR-PO each for a paging record and the number of LR-PMOs depends on the variable size of the paging message (e.g., depending on a number of UEs paged). In one or more implementations, a codepoint at the beginning of the LR-PO can indicate a number of LR-PMOs in a LR paging occasion which can be monitored by all UEs, secondly can have an indication where there is no page in this occasion and other reason for the page such as any emergency notification, system information update, and so forth. Additionally, or alternatively, a sync word with fixed word (0xF0) can be kept at the end of the LR-PO indicating the end of LR-PO transmission. The UEs can be configured to monitor all LR-PMOs within a LR-PO since the UE does not know the monitoring occasion to receive paging otherwise, the UE can be configured with monitoring occasion in a LR-PO.

Each paging record contains 5G-S-TMSI or inactive radio network temporary identifier (I-RNTI) used in RRC-Inactive and in addition can indicate whether the paging is for the IP multimedia subsystem (IMS) voice. In one or more implementations, there can be a separate low power wake-up signal occasion (LO) configured to be monitored by all UEs such as short messaging notification related to emergency, system information, and so forth. Additionally, or alternatively, similarly to 5G, a subgrouping of paging occasions can be supported by creating subgrouping of UEs with UE ID and the subgrouping further indicates which subgroups of UEs have a paging message and UEs belonging to the subgroup wake up and monitor the LR-POs.

In one or more implementations, the LR-PO and the legacy PO configurations are the same. For example, if the legacy PO per paging cycle is 2, the LR-PO per paging cycle is also 2, so the LP-WUR is configured to monitor 2 LR-POs per paging cycle.

Additionally, or alternatively, the UE maybe configured to monitor LR-PO as a subfactor of the legacy number of PO in a paging cycle. For example, when the legacy PO per paging cycle is 2, and when the subfactor is configured as ½, then the UE's LP-WUR is configured to monitor 1 LR-PO per paging cycle. By way of another example, when the legacy PO per paging cycle is 1, then the subfactor of ½ allows the UE's LP-WUR to monitor one LR-PO every two paging cycles.

Returning to FIG. 5, a modulated constellation, e.g., quadrature phase shift keying (QPSK) can be used to transmit 5G-S-TMSI bits in each LR-PMO.

An orthogonal ZC sequence generated using a cyclic shift can provided to a UE or a group of UEs and the generated sequence can be DFT-s-spreaded within the LP-WUS bandwidth and then mapped together legacy channels in the inverse fast Fourier transform (IFFT) grid. The number of chips of sequences within an OFDM symbol can be indicated using a M value. The monitoring occasion can be multiplexed in terms of time, frequency and code domain to indicate one or more UEs.

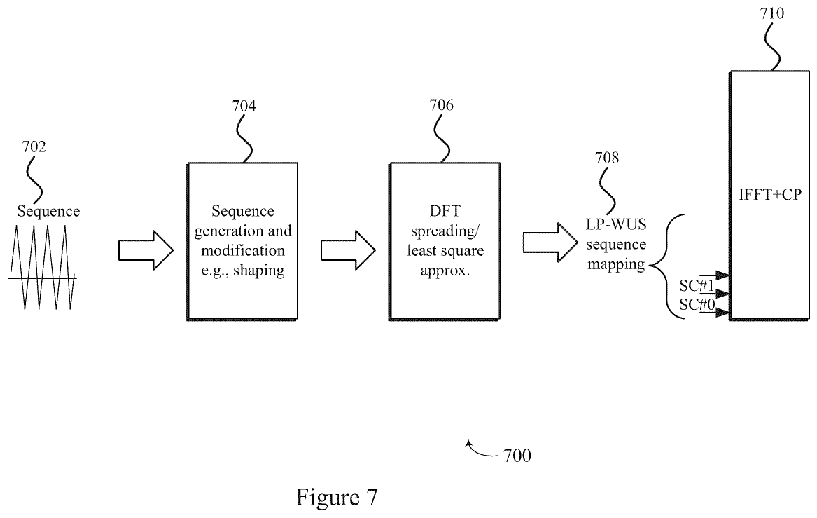

FIG. 7 illustrates an example 700 of an LP-WUS sequence generation in accordance with aspects of the present disclosure. The example 700 is an example of DFT-s-spreaded LP-WUS sequence generation. As illustrated in the example 700, a sequence 702 is input to a sequence generator and modifier 704, e.g., which shapes the sequence 702. The result is input to a DFT spreader/least square approximator 706, which outputs a LP-WUS 708 that is provided to an IFFT 710 to generate an OFDM symbol that is enhanced with a cyclic prefix (CP).

The LP-WUS sequence can be mapped to a 5G-S-TMSI and a LR-PMO in any of a variety of different manners. In one or more implementations, the 5G-S-TMSI bits can be divided into N groups of Q bits in each group. 2^{Q} sequences represent Q bits that can be configured to represent 5G-S-TMSI in a LR-PMO. For example, a first sequence can represent the first Q bits of the 5G-S-TMSI, a second sequence can represent the second Q bits of the 5G-S-TMSI, and so on. This reduces the payload size and correlation complexity at the UE side. There can optionally be a number ‘M’ of sequences before DFT spreading per OFDM symbol, and each of the M sequences represents a group of Q bits. OOK-4 can be used, where M=4 chips per OFDM symbol, and the sequences are transmitted in the ON duration of OOK-4. Both the group of sequences and the OOK-4 chips represent the 5G-s-TMSI.

Additionally, or alternatively, every UE monitoring 5G-S-TMSI within a LR-PMO can be configured (e.g., by the NE) with a particular sequence (e.g., a sequence of numbers) transmitted in a LR-PMO. Each UE monitoring a LR-PMO can be configured with a unique (e.g., within the LR-PMO) sequence and the successful reception of the sequence implies a successful paging indication. Since there are limited sequences, the same sequence can be repeated in another LR-PMO for another UE monitoring another 5G-S-TMSI for paging.

Additionally, or alternatively, a base sequence using a sequence identifier can be configured for a LR-PMO and each UE with 5G-S-TMSI monitoring a LR-PMO can have a unique (e.g., within the LR-PMO) cyclic shift generating orthogonal sequence from the base sequence. The UEs LR-PMOs can be code division multiplexed (CDMed) using cyclic shifts as shown in the below figure.

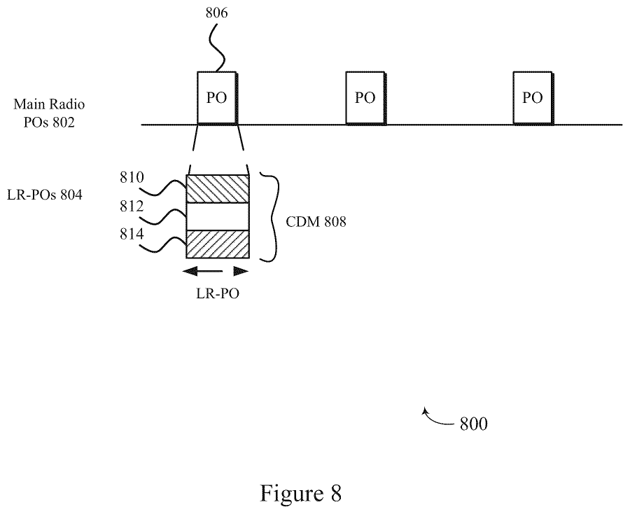

FIG. 8 illustrates an example 800 of code division multiplexing in accordance with aspects of the present disclosure. The example 800 illustrates main radio POs 802 and LR-POs 804. For a PO 806, a base sequence (e.g., a sequence of numbers) for a LR-PMO being CDMed 808. For example, three different cyclic shifts 810, 812, and 814 from a base sequence are illustrated to identify three different 5G-S-TMSIs.

Returning to FIG. 5, if at 516 the paging is not successful, at 518 the LP-WUR performs at least one intra-frequency cell measurement and/or at least one inter-frequency cell measurement and determines, based on these one or more measurements, whether to perform reselection to another cell. This determination can be based on various criteria, such as whether the intra-frequency cell measurement drops below a threshold value, whether an inter-frequency measurement is higher than an intra-frequency measurement, and so forth. If the current cell measurements fall below a threshold and/or are exceeded by an inter-frequency measurement, at 520 the LP-WUR performs reselection to another cell.

However, if at 516 the paging is successful, at 522 the LP-WUR wakes up (e.g., powers on) the main radio, and at 524 the main radio transmits RACH.

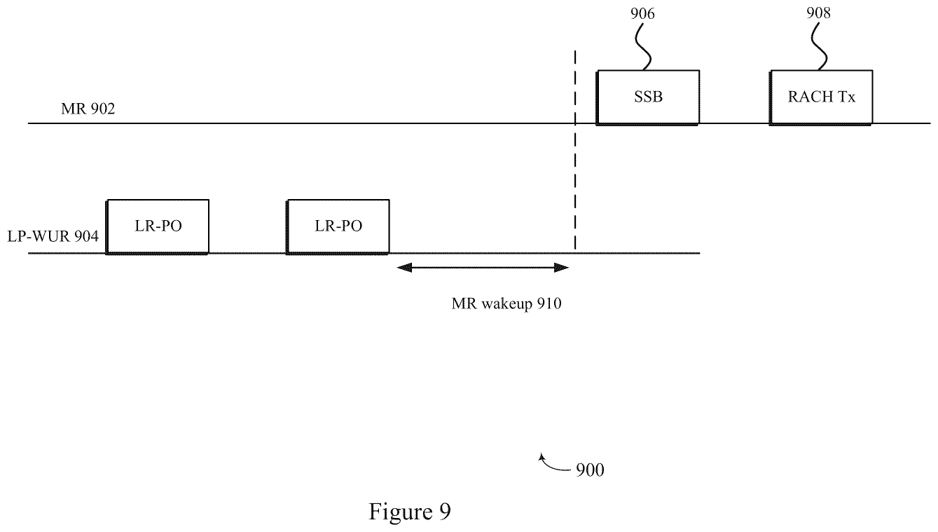

FIG. 9 illustrates an example 900 of a main radio wake-up delay in accordance with aspects of the present disclosure. The example 900 illustrates a mapping between LR-PMO and MR-RACH occasions considering wake-up delay. The example 900 illustrates a main radio 902 (e.g., a main radio 208 of FIG. 2 or a main radio 408 of FIG. 4) and a LP-wur 904 (e.g., a LP-WUR 206 of FIG. 2 or a LP-WUR 406 of FIG. 4).

Typically, the mapping definition is between SSB 906 and RACH occasion 908, since the LP-WUR monitors SSB and the new LR-PMO duration can be longer than the PO occasion due to mapping of paging record of every UE to each LR-PMO meaning one to many relationship in terms of occasion mapping between PO and LR-PMO, a new mapping definition rule may be specified to map resources between the LR paging occasion(s) within a paging cycle or a group of paging occasion(s) in a paging cycle to that of RACH occasion(s). In the above definition, the LR PO(s) corresponding to a SSB beam can be mapped to a RACH occasion(s). Since the main radio of a UE wakes up to transmit RACH, the RACH resource mapping with respect to the LR-PMO takes into consideration the main radio wake-up delay 910. The LR PMO of a beam can be associated with a different RACH occasion of the same reception beam used for transmission of SSB at the base station with different offsets by taking into consideration the wake-up delay 910 of the main radio. The association period can be defined between the LR PMO and RACH, to enable all paging resources of a paging cycle of LP-WUR to be mapped to a RACH resource. Here, there can be more LR-paging occasions or LR-paging frames mapped to a single RACH occasion, or also a single LR-paging occasion can mapped to a set of RACH occasions, or a combination thereof. The NE (e.g., a base station) can configure the UE with the mapping of LR-paging occasion(s) to RACH occasion(s).

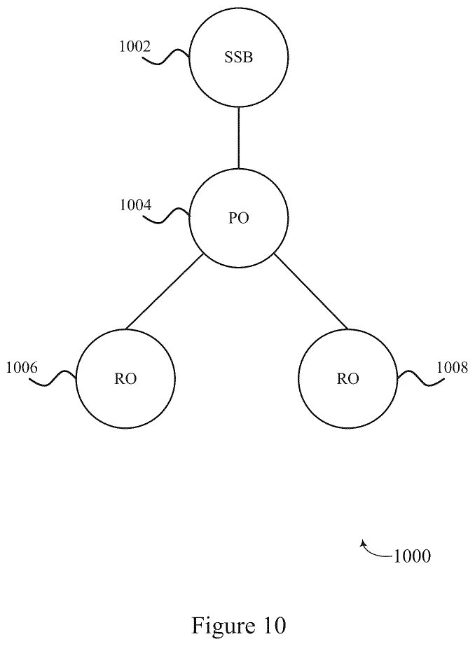

FIG. 10 illustrates an example 1000 of mapping SSB-Lower power paging occasions to RACH occasions. In the example 1000, one SSB 1002 associated with ‘X’, X>1 RACH occasions (ROs), one low power PO 1004 (e.g., a LR-PO) within a paging frame is associated to ‘1/N’ RACH occasions 1006, 1008, where 1/N is a factor introduced to further partition the RACH occasions to that of the low power paging occasions within a paging frame(s). Such partition of RACH resources can be provided in a combination of time-frequency and code domain.

Returning to FIG. 2 or FIG. 4, with respect to the LP-WUR paging cycle, the LP-WUR paging cycle can be the same as that of the idle mode discontinuous reception (IDRX) cycle configured for the main radio 208 or the main radio 408, which means that legacy paging cycle used in the main radio and the LP-WUR paging cycle can be same.

Additionally, or alternatively, LP-WUR paging cycle can be an integer or non-integer multiple of the main radio paging cycle, which means that when the legacy paging cycle of the main radio is 32 radio frames, i.e., 320 ms, the LP-WUR paging cycle can be 640 ms to enable more resources for the transmission of LP-WUR paging messages. The LP-WUR duty cycle can be configured such that it is a multiple of the legacy paging cycle of the main radio.

In one or more implementations, there can be a separate LP-WUR paging formula to calculate the LP-WUR paging frame and LP-WUR paging monitoring occasions.

In one or more implementations, after receiving the common channel information from the low power signal, the UE 404 deduces the presence of individual bursts within the common channel burst, e.g., SSB, paging, CORESET #0, system information block (SIB) 1 and RACH occasion. A common control signaling, i.e., using group common low power radio signaling or group common physical downlink control channel (PDCCH), may convey the configuration of one or more of these channels: presence or absence of these channels (e.g., individual codepoint for each of these channels); adaptation of periodicity of these channels (e.g., periodicity switching for each of these channels); spatial direction information common across channels (e.g., not transmitting SSB in a beam resulting in not transmitting physical layer broadcast channel (PBCH) and other minimum system information (MSI) information, paging and no RACH resource); presence of any on-demand channel (e.g., on-demand SSBs or on-demand SIB1).

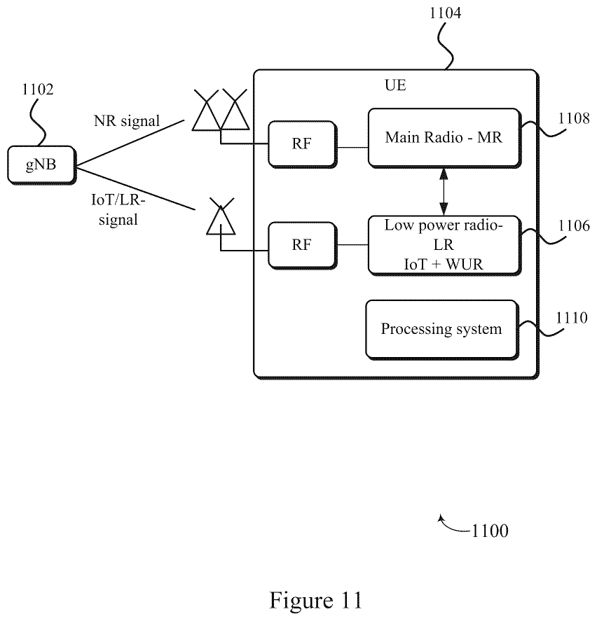

FIG. 11 illustrates an example 1100 of a LP-WUR design architecture in accordance with aspects of the present disclosure. The example 1100 is similar to the example 400 of FIG. 4, including a NE 1102 (e.g., a base station) and a UE 1104, except that the functionality of the wake-up radio is integrated with that of the low data rate IoT radio and processor in a low power radio 1106. This means the low power radio 1106 handles the wake-up of the main radio 1108 (and optionally an associated processor), which has high power consumption for complex high data rate traffic, while the low power radio 1106 (and optionally an associated processor) in addition to the wake-up may also handle the low data rate traffic. A processing system 1110 that includes processor circuitry and memory circuitry is also illustrated. Although illustrated as separate from the low power radio 1106 and the main radio 1108, additionally, or alternatively, the processing system 1110 may be included in the low power radio 1106 and/or the main radio 1108.

The main radio 1108 can be woken up only when the downlink (DL) received data rate exceeds a certain threshold, which can be provided as a UE capability to the NE 1102 or preconfigured in the specification. Since the NE 1102 is aware and controls the DL transmission rate to the UE 1104, the NE 1102 wakes up the main radio 1108 of the UE 1104 to transmit high data rate traffic.

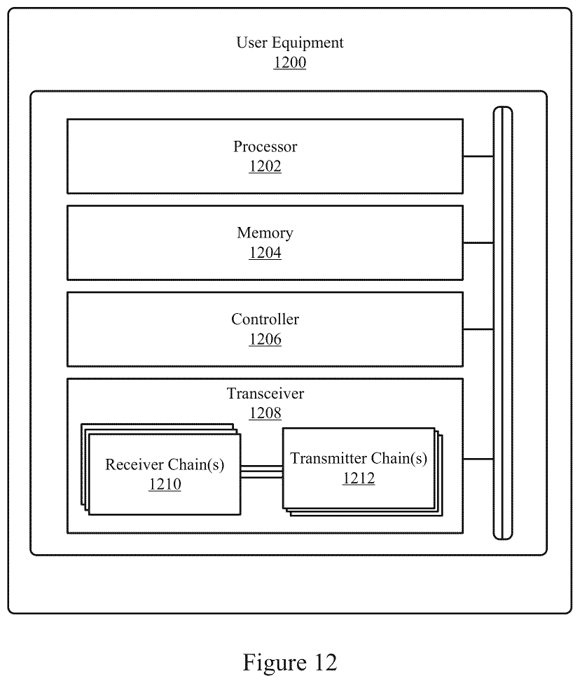

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for monitoring for at least one paging message during one or more LR-POs and using a low power radio of the UE; and powering on a main radio of the UE based at least in part on a reception of the at least one paging message during at least one LR-PO of the one or more LR-POs.

Additionally, the UE 1200 may be configured to support any one or combination of performing one or more of intra-frequency cell measurement or inter-frequency cell measurement using the low power radio of the UE; and performing a cell selection or a cell reselection based at least in part on one or more of the performed intra-frequency cell measurement or the performed inter-frequency cell measurement; further including receiving a configuration that indicates the at least one LR-PO; further including receiving a configuration that indicates at least one paging cycle of one or more paging cycles, where the at least one paging message is monitored for during the at least one paging cycle; where a sequence length of a TMSI of the UE is based at least in part on N x Q bits, where N refers to a number of groups, and where Q refers to a number of bits per group; further including receiving a configuration that indicates a sequence; and detecting reception of the at least one paging message during the at least one LR-PO based at least in part on reception of the sequence during the at least one LR-PO; further including receiving a configuration that indicates a cyclic shift from a base sequence; and detecting reception of the at least one paging message during the at least one LR-PO based at least in part on reception of the base sequence having the cyclic shift during the at least one LR-PO.

Additionally, or alternatively, the UE 1200 may support at least one memory (e.g., the memory 1204) and at least one processor (e.g., the processor 1202) coupled with the at least one memory and configured to cause the UE to: monitor for at least one paging message during one or more LR-POs and using the low power radio of the UE; and power on the main radio of the UE based at least in part on a reception of the at least one paging message during at least one LR-PO of the one or more LR-POs.

Additionally, the UE 1200 may be configured to support any one or combination of the at least one processor is configured cause the UE to perform one or more of intra-frequency cell measurement or inter-frequency cell measurement using the low power radio of the UE; and perform a cell selection or a cell reselection based at least in part on one or more of the performed intra-frequency cell measurement or the performed inter-frequency cell measurement; where the processing system is further operable to cause the UE to receive a configuration that indicates the at least one LR-PO; where the processing system is further operable to cause the UE to receive a configuration that indicates at least one paging cycle of one or more paging cycles, where the at least one paging message is monitored for during the at least one paging cycle; where a sequence length of a TMSI of the UE is based at least in part on N×Q bits, where N refers to a number of groups, and where Q refers to a number of bits per group; receive a configuration that indicates a sequence; and detect reception of the at least one paging message during the at least one LR-PO based at least in part on reception of the sequence during the at least one LR-PO; receive a configuration that indicates a cyclic shift from a base sequence; and detect reception of the at least one paging message during the at least one LR-PO based at least in part on reception of the base sequence having the cyclic shift during the at least one LR-PO.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

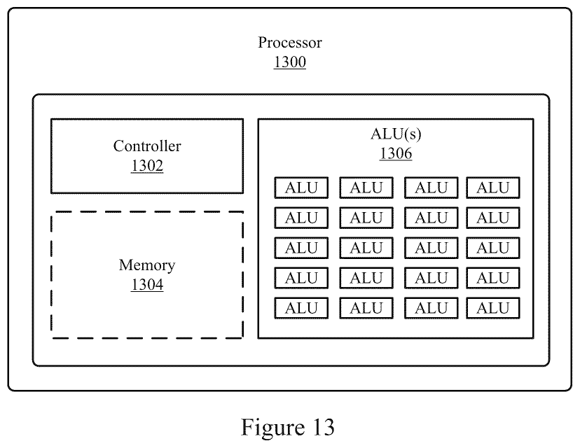

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to: monitor for at least one paging message during one or more LR-POs and using a low power radio of a UE that includes the processor; and power on a main radio of the UE based at least in part on a reception of the at least one paging message during at least one LR-PO of the one or more LR-POs.

Additionally, the processor 1300 may be configured to or operable to support any one or combination of the at least one controller is further operable to cause the processor to perform one or more of intra-frequency cell measurement or inter-frequency cell measurement using the low power radio of the UE; and perform a cell selection or a cell reselection based at least in part on one or more of the performed intra-frequency cell measurement or the performed inter-frequency cell measurement; where the at least one controller is further operable to cause the processor to receive a configuration that indicates the at least one LR-PO; where the at least one controller is further operable to cause the processor to receive a configuration that indicates at least one paging cycle of one or more paging cycles, where the at least one paging message is monitored for during the at least one paging cycle; where a sequence length of a TMSI of the UE is based at least in part on N x Q bits, where N refers to a number of groups, and where Q refers to a number of bits per group; where the at least one controller is further operable to cause the processor to receive a configuration that indicates a sequence; and detect reception of the at least one paging message during the at least one LR-PO based at least in part on reception of the sequence during the at least one LR-PO; where the at least one controller is further operable to cause the processor to receive a configuration that indicates a cyclic shift from a base sequence; and detect reception of the at least one paging message during the at least one LR-PO based at least in part on reception of the base sequence having the cyclic shift during the at least one LR-PO.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to: transmit a configuration for low power radio paging; and transmit at least one paging message during at least one LR-PO of one or more LR-POs.

Additionally, the processor 1300 may be configured to or operable to support any one or combination of where the configuration indicates the at least one LR-PO; where the configuration indicates at least one paging cycle of one or more paging cycles for a UE to monitor; where a sequence length of a TMSI of a UE is based at least in part on N x Q bits, where N refers to a number of groups, and where Q refers to a number of bits per group; where the configuration indicates a sequence, and the at least one controller is further operable to cause the processor to transmit the sequence during the at least one LR-PO; where the configuration indicates a cyclic shift from a base sequence, and the at least one controller is further operable to cause the processor to transmit the base sequence having the cyclic shift during the at least one LR-PO.

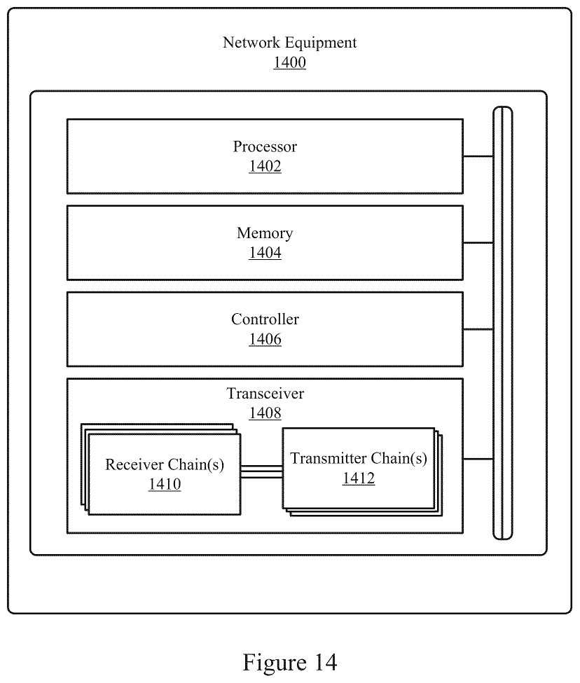

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to support a means for transmitting a configuration for low power radio paging; and transmitting at least one paging message during at least one LR-PO of one or more LR-POs.

Additionally, the NE 1400 may be configured to support any one or combination of where the configuration indicates the at least one LR-PO; where the configuration indicates at least one paging cycle of one or more paging cycles for a UE to monitor; where a sequence length of a TMSI of a UE is based at least in part on N×Q bits, where N refers to a number of groups, and where Q refers to a number of bits per group; where the configuration indicates a sequence, and further including transmitting the sequence during the at least one LR-PO; where the configuration indicates a cyclic shift from a base sequence, and further including transmitting the base sequence having the cyclic shift during the at least one LR-PO.

Additionally, or alternatively, the NE 1400 may support at least one memory (e.g., the memory 1404) and at least one processor (e.g., the processor 1402) coupled with the at least one memory and configured to cause the NE to: transmit a configuration for low power radio paging; and transmit at least one paging message during at least one LR-PO of one or more LR-POs.

Additionally, the NE 1400 may be configured to support any one or combination of where the configuration indicates the at least one LR-PO; where the configuration indicates at least one paging cycle of one or more paging cycles for a UE to monitor; where a sequence length of a TMSI of a UE is based at least in part on N×Q bits, where N refers to a number of groups, and where Q refers to a number of bits per group; where the configuration indicates a sequence, and the at least one processor is further operable to cause the NE to transmit the sequence during the at least one LR-PO; where the configuration indicates a cyclic shift from a base sequence, and the at least one processor is further operable to cause the NE to transmit the base sequence having the cyclic shift during the at least one LR-PO.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

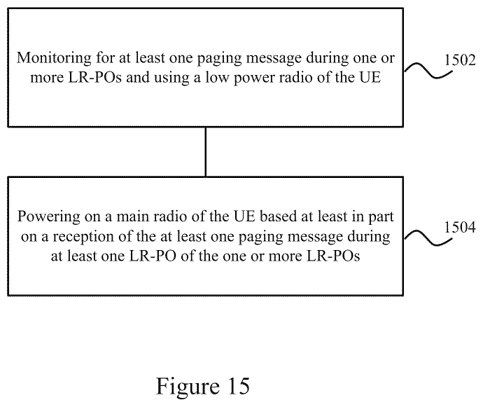

FIG. 15 illustrates a flowchart of a method in accordance with aspects of the present disclosure. The operations of the method may be implemented by a UE as described herein. In some implementations, the UE may execute a set of instructions to control the function elements of the UE to perform the described functions.

At 1502, the method may include monitoring for at least one paging message during one or more LR-POs and using a low power radio of the UE. The operations of 1502 may be performed in accordance with examples as described herein. In some implementations, aspects of the operations of 1502 may be performed by a UE as described with reference to FIG. 12.

At 1504, the method may include powering on a main radio of the UE based at least in part on a reception of the at least one paging message during at least one LR-PO of the one or more LR-POs. The operations of 1504 may be performed in accordance with examples as described herein. In some implementations, aspects of the operations of 1504 may be performed by a UE as described with reference to FIG. 12.

It should be noted that the method described herein describes a possible implementation, and that the operations and the steps may be rearranged or otherwise modified and that other implementations are possible.

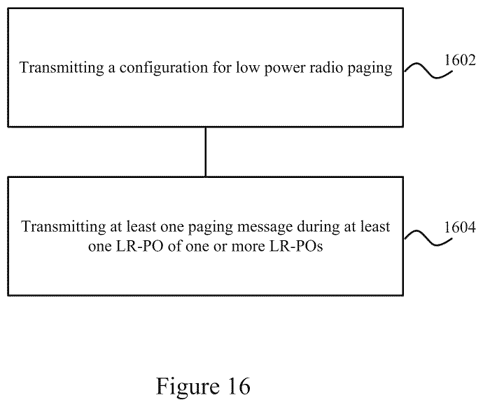

FIG. 16 illustrates a flowchart of a method in accordance with aspects of the present disclosure. The operations of the method may be implemented by a NE as described herein. In some implementations, the NE may execute a set of instructions to control the function elements of the NE to perform the described functions.

At 1602, the method may include transmitting a configuration for low power radio paging. The operations of 1602 may be performed in accordance with examples as described herein.

In some implementations, aspects of the operations of 1602 may be performed by a NE as described with reference to FIG. 14.

At 1604, the method may include transmitting at least one paging message during at least one LR-PO of one or more LR-POs. The operations of 1604 may be performed in accordance with examples as described herein. In some implementations, aspects of the operations of 1604 may be performed by a NE as described with reference to FIG. 14.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
a low power radio;
a main power radio; and
a processing system that includes processor circuitry and memory circuitry, the processing system operable to cause the UE to:
monitor for at least one paging message during one or more low power radio paging occasions (LR-POs) and using the low power radio of the UE; and
power on the main radio of the UE based at least in part on a reception of the at least one paging message during at least one LR-PO of the one or more LR-POs.

2. The UE of claim 1, wherein the processing system is further operable to cause the UE to:
perform one or more of intra-frequency cell measurement or inter-frequency cell measurement using the low power radio of the UE; and
perform a cell selection or a cell reselection based at least in part on one or more of the performed intra-frequency cell measurement or the performed inter-frequency cell measurement.

3. The UE of claim 1, wherein the processing system is further operable to cause the UE to receive a configuration that indicates the at least one LR-PO.

4. The UE of claim 1, wherein the processing system is further operable to cause the UE to receive a configuration that indicates at least one paging cycle of one or more paging cycles, wherein the at least one paging message is monitored for during the at least one paging cycle.

5. The UE of claim 1, wherein a sequence length of a temporary mobile subscriber identity (TMSI) of the UE is based at least in part on N x Q bits, wherein N refers to a number of groups, and wherein Q refers to a number of bits per group.

6. The UE of claim 1, wherein the processing system is further operable to cause the UE to:
receive a configuration that indicates a sequence; and
detect reception of the at least one paging message during the at least one LR-PO based at least in part on reception of the sequence during the at least one LR-PO.

7. The UE of claim 1, wherein the processing system is further operable to cause the UE to:
receive a configuration that indicates a cyclic shift from a base sequence; and
detect reception of the at least one paging message during the at least one LR-PO based at least in part on reception of the base sequence having the cyclic shift during the at least one LR-PO.

8. A network equipment (NE) for wireless communication, comprising:
at least one memory; and
at least one processor coupled with the at least one memory and operable to cause the NE to:
transmit a configuration for low power radio paging; and
transmit at least one paging message during at least one low power radio paging occasion (LR-PO) of one or more LR-POs.

9. The NE of claim 8, wherein the configuration indicates the at least one LR-PO.

10. The NE of claim 8, wherein the configuration indicates at least one paging cycle of one or more paging cycles for a user equipment (UE) to monitor.

11. The NE of claim 8, wherein a sequence length of a temporary mobile subscriber identity (TMSI) of a user equipment (UE) is based at least in part on N x Q bits, wherein N refers to a number of groups, and wherein Q refers to a number of bits per group.

12. The NE of claim 8, wherein the configuration indicates a sequence, and the at least one processor is further operable to cause the NE to transmit the sequence during the at least one LR-PO.

13. The NE of claim 8, the configuration indicates a cyclic shift from a base sequence, and the at least one processor is further operable to cause the NE to transmit the base sequence having the cyclic shift during the at least one LR-PO.

14. A method performed by a user equipment (UE), the method comprising:
monitoring for at least one paging message during one or more low power radio paging occasions (LR-POs) and using a low power radio of the UE; and
powering on a main radio of the UE based at least in part on a reception of the at least one paging message during at least one LR-PO of the one or more LR-POs.

15. The method of claim 14, further comprising:
performing one or more of intra-frequency cell measurement or inter-frequency cell measurement using the low power radio of the UE; and
performing a cell selection or a cell reselection based at least in part on one or more of the performed intra-frequency cell measurement or the performed inter-frequency cell measurement.

16. The method of claim 14, further comprising receiving a configuration that indicates the at least one LR-PO.

17. The method of claim 14, further comprising receiving a configuration that indicates at least one paging cycle of one or more paging cycles, wherein the at least one paging message is monitored for during the at least one paging cycle.

18. A method performed by a network equipment (NE), the method comprising:
transmitting a configuration for low power radio paging; and
transmitting at least one paging message during at least one low power radio paging occasion (LR-PO) of one or more LR-POs.

19. The method of claim 18, wherein the configuration indicates the at least one LR-PO.

20. The method of claim 18, wherein the configuration indicates at least one paging cycle of one or more paging cycles for a user equipment (UE) to monitor.
